(19) United States
(12) Patent Application Publication
(10) Pub. No.: US 2022/0063068 A1
(43) Pub. Date: Mar. 3, 2022

(54) RFID/NFC ENABLED FITTINGS, SMART TORQUE TOOL SYSTEM, AND TORQUE SENSING FITTING

(71) Applicant: Parker-Hannifin Corporation, Cleveland, OH (US)

(72) Inventors: Jason D. PATCH, Columbus, OH (US); Nathan L. GREEN, Galloway, OH (US); Diane M. ARTMAN, Columbus, OH (US); Le YU, Dublin, OH (US)

(21) Appl. No.: 17/420,213

(22) PCT Filed: Feb. 21, 2020
(86) PCT No.: PCT/US2020/019133

§ 371 Date: Jul. 1, 2021

Related U.S. Application Data
(60) Provisional application No. 62/809,889, filed on Feb. 25, 2019.

(51) Int. Cl. B25B 23/142; G01L 5/24; G06K 7/10; G06K 19/07; G06K 7/14

(52) U.S. Cl. CPC B25B 23/1425; G01L 5/24; G06K 7/10297; G06K 7/10366; F16L 19/0237; G06K 7/1417; G06K 7/1413; F16L 2201/10; G06K 19/0709

(57) ABSTRACT

A smart torque system includes a fitting comprising a fitting body defining a fluid flow passage from a first end to a second end, and an electronically readable element that is configured to store information about the fitting including at least a torque requirement of the fitting; an electronic reading device that reads the torque requirement from the electronically readable element; and a torque tool that is programmable by the reading device to set a torque to be applied by the torque tool in accordance with the torque requirement. The electronically readable element may include an RFID or NFC storage device, or a patterned code element, that is read by a complementary reading device. The electronic reading device may be incorporated into the torque tool. In another aspect, a fitting includes a fitting body defining a fluid flow passage from a first end to a second end, and an integrated torque sensor. The integrated torque sensor includes an electronic sensor element; a push pin that is engageable with the electronic sensor element to close a circuit connected to the electronic sensor element; and a biasing element that is configured to actuate the pushpin. When the fitting is torqued in accordance with a torque requirement of the fitting, the biasing element actuates the push pin to engage with the electronic sensor element to close the circuit, and a stored data item within the electronic sensor element changes to indicate the fitting is torqued in accordance with the torque requirement.

### RELATED APPLICATIONS

This application claims the benefit of U.S. Provisional Application No. 62/809,889 filed on Feb. 25, 2019, the contents of which are incorporated herein by reference.

### FIELD OF INVENTION

The present invention relates generally to fittings and related torque tools for tightening such fittings, and quality control and inventory tracking of such devices.

### BACKGROUND OF THE INVENTION

Fittings that are employed to connect adjacent sections of pipes, tubing, fluid flow equipment, and the like are used in a variety of industries and applications. Such fittings are tightened using a suitable torque tool, such as a wrench or like device that tightens the fitting to a desired torque. Torque tools come in a variety of forms, and may be manual or powered.

Depending upon the application, the appropriate or optimal level of torque applied to the fitting can vary. Accordingly, users at times make tightening errors by under torqueing or over torqueing fittings, as conventional systems typically have no way to indicate when proper torque is applied. Improper torqueing can cause leaks, and thus is highly undesirable. For large assemblies with numerous fittings, often times such assemblies are connected in a gross fashion and then the individual fittings are torqued as a finishing assembly step. Sometimes, due to the large number of fittings, there are occurrences in which users miss fittings and never torque them, which also can result in leaks. Relatedly, in large assemblies in particular, users commonly need to be able to identify particular fittings for inspection and maintenance purposes. In different sections of a broader assembly, different fittings may be used which have different torque requirements. Identifying fittings and their associated torque requirements can be a laborious task in a large assembly and is subject to errors.

### SUMMARY OF THE INVENTION

There is a need in the art, therefore, for an improved torque system of torque tools and fittings that aid in quality assurance to ensure the proper application of torque, and to enhance fitting tracking and identification. One aspect of the invention is a smart torque system including a smart fitting and a smart torque tool. In exemplary embodiments, an electronic reading system, such as for example a barcode or other patterned code reading system, or a radio frequency identification (RFID) or near field communication (NFC) antenna and chips, are embedded or attached to fittings, providing quick data reference and other optional capabilities of providing information about the fitting. RFID/NFC or readable code fittings may be read by a custom electronic torque wrench or other torque tool with an embedded reader, which can read the torque requirement and automatically set the correct torque value based on the read fitting operational parameters. Alternatively, a wired or wireless RFID/NFC or patterned code reader could query the fitting, and then program the torque wrench or other torque tool via a wired or wireless connection to the torque tool. Optionally, the torque tool could then write a torque confirmation data item to the RFID/NFC chip, enabling faster post-inspection. In conjunction with enhanced inspection capabilities, a light-emitting diode (LED) may be added to the RFID/NFC chip that would be a different color or flash pattern after the torque confirmation was written, powered by an RFID antenna. The smart torque system may be electronically connected, such as by a wired or wireless connection, to a broader asset tracking system to further aid in identifying, maintaining, and inspecting fittings in a large assembly.

Another aspect of the invention is a fitting including an integrated torque sensor. In exemplary embodiments, the fitting body and/or nut contains an electronic sensor element, such as for example an RFID/NFC antenna and chip. At a given torque value, a biasing element will actuate a conductive push pin, thereby closing a circuit that is connected to the RFID/NFC chip. The closing of the circuit changes an internal value stored in the chip such that the fitting would recognize it has been torqued. This eliminates the need for a specialized torque wrench to ascertain the appropriate torque. In exemplary embodiments, the fitting with an integrated torque sensor may be paired with a light-emitting diode (LED) that would change color, flash rate, or other indicator mode when the sensor element circuit is closed, allowing for visual feedback when the RFID/NFC chip is powered (e.g., via wireless induction as per that technology). Alternatively, the RFID/NFC antenna could be used with an LED light only, not a chip, thus allowing visual feedback when the acceptable torque is reached. This could be beneficial because depending on the RFID range, multiple fittings or even the whole assembly could be wirelessly powered at the same time, enabling visual torqueing of all fittings and quick visual post quality assembly inspection, and at lower cost than the full RFID chip version.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto. Features that are described and/or illustrated with respect to one embodiment may be used in the same way or in a similar way in one or more other embodiments and/or in combination with or instead of the features of the other embodiments.

### BRIEF DESCRIPTION OF THE DRAWINGS

FIG. 1 is a drawing depicting a smart fitting in accordance with embodiments of the present application.

FIG. 2 is a drawing depicting another configuration of a smart fitting in accordance with embodiments of the present application.

FIG. 3 is a drawing depicting a smart torque system including the fitting and a smart torque tool in accordance with embodiments of the present application.

FIG. 4 is a drawing depicting a fitting including an integrated torque sensor in accordance with embodiments of the present application.

### DETAILED DESCRIPTION

Embodiments of the present invention will now be described with reference to the drawings, wherein like reference numerals are used to refer to like elements throughout. It will be understood that the figures are not necessarily to scale.

One aspect of the invention is a smart torque system including a fitting and a torque tool. In exemplary embodiments, an electronic reading system, such as for example a barcode or other patterned code reading system, or a radio frequency identification (RFID) system or near field communication (NFC) antenna and chips, are embedded or attached to fittings, providing quick data reference and other optional capabilities of providing information about the fitting.

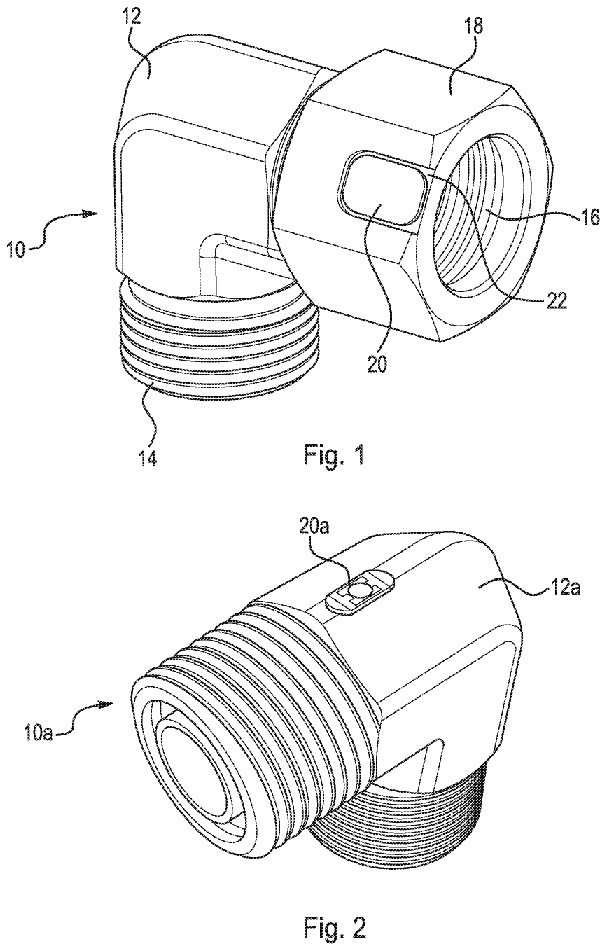

FIG. 1 is a drawing depicting a “smart” fitting 10 in accordance with embodiments of the present application. The fitting 10 includes a fitting body 12 that defines a fluid pathway between a first end 14 and a second end 16. The second end 16 includes a nut 18 for connection to a pipe section, tubing, or the like. In this example, the nut 18 is provided with an electronically readable element 20. In exemplary embodiments, electronically readable element 20 may be an electronic storage element, for example an RFID device or NFC chip, or a patterned code element, for example a barcode or QR code element. The electronically readable element 20 may be applied using an adhesive or by any suitable means, and may be embedded in a recess 22 in the nut 18 as shown in this example. After placing the electronically readable element 20, the recess may be covered by a resin or other suitable material covering that can hold the electronic storage element in place while still enabling electronic reading.

When the electronically readable element 20 is configured as an electronic storage element, the electronic storage element 20 may be programmed to store pertinent information about the fitting. The electronic storage element preferably stores as data at least the torque requirement for the fitting. The torque requirement may be programmed onto the electronic storage element on site using a suitable transmission device, or may be pre-programed onto the electronic storage element during initial manufacturing. Such torque requirement may be read out from the electronic storage element using any suitable electronic reading device. In this manner, a technician on-site can readily read the torque requirement off of the fitting to ensure that the fitting is torqued within an acceptable range in accordance with the torque requirement data stored on the electronic storage element.

The electronic storage element 20 further may be programmed to store additional information pertaining to the fitting 10. Such additional information, for example, may include fitting identifying information (e.g., part number, part description, manufacturer, and the like), pertinent dates that are related to maintenance issues such as installation and/or inspection dates, website or URL links, and other suitable information that may be useful in connection with fitting identification and maintenance.

In other exemplary embodiments, the electronically readable element 20 may be a passive patterned code element, such as a barcode or QR code element. The patterned code may be correlated to a particular torque requirement or value, which then can be read by any appropriate electronic code reader, such as for example a barcode or QR code scanner. Alternatively, the patterned code may be correlated to product identifying information, such as a product number or other product identifier. The product identifying information then may be used as a cross-reference to an associated electronic database by which the product identifying information may be cross-referenced to the torque requirement. The database may be located on any suitable electronic storage system, such as for example a local computing device (such as a mobile or desktop computing device, including for example a tablet computer or mobile phone), or a remote server or cloud database that is accessible by a wired or wireless communication device.

In the example of FIG. 1, the electronically readable element 20 is provided on or embedded within the nut 18. In an alternative embodiment as illustrated in FIG. 2 of a fitting 10a, an electronically readable element 20a may be provided on or embedded within the fitting body 12a. The electronically readable element 20a also may be an electronic storage element as an RFID device or NFC chip, or a passive patterned code element such as a barcode or QR code element. In addition, although only one electronically readable element is shown in the figures, multiple electronically readable elements may be employed within a single fitting 10/10a. For example, multiple electronically readable elements may be used at each end of the fitting when torque requirements may differ as between the first end 14 and the second end 16. In another variation when torque requirements differ for the fitting ends, torque requirements for both ends may be programmed or coded onto a single electronic storage element or patterned code element applied to the fitting.

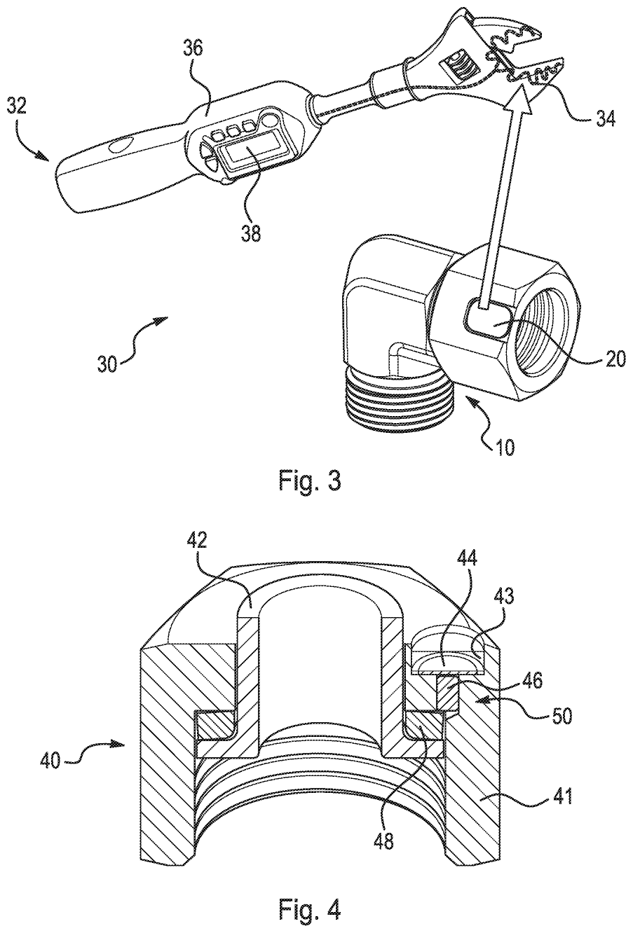

As part of the smart torque system, the fitting 10 (or 10a) may be paired with a smart torque tool that includes an electronic reader that can read information from, and/or when applicable program information to, the fitting 10. FIG. 3 is a drawing depicting a smart torque system 30 including the fitting 10 and a smart torque tool 32. The torque tool 32 is shown as a torque wrench in this example, although any suitable torque tool may be employed. The torque tool 32 includes an electronic reader 34 that can read information off of the electronically readable element 20 (RFID/NFC chip or patterned code element) on the fitting 10. For example, when the electronically readable element 20 is an electronic storage element such as an RFID/NFC chip, the RFID/NFC chip on the fittings could be read by a custom electronic torque wrench or other torque tool 32 with the embedded reader 34 to read out the torque requirements of the fitting 10. When the electronically readable element 20 is a passive patterned code element such as a barcode or QR code element, the patterned code element on the fittings could be read by the embedded reader 34 that is a suitable patterned code scanner to read out the torque requirements of the fitting 10. Accordingly, the torque tool can read the torque requirement and then automatically set the correct torque value to be applied by the torque tool based on the fitting operational parameters.

The torque tool 32 may include an electronics housing 36 that houses the electronic components associated with the smart torque system. The electronic components may include a battery for powering the electronic reader 34, which in a passive system also provides power by induction to the electronic storage element being read. The electronic components also may include an electronic indicator 38 to provide outputs to a user. The electronic indicator 38 may include a readout display to provide information to a user, such as for example an indication of when the acceptable torque has been applied, and/or a display of any fitting information read from the electronically readable element 20, such as information stored on an electronic storage element or that is coded onto a patterned code element. Light-emitting diode (LED) indicators also may be used to indicate acceptable torqueing of the fitting, which can provide such indication to the user based on a color, flashing pattern, or other suitable output. Other indicators may be employed to indicate acceptable torqueing, such as for example tactile indicators such as a “click” when the acceptable torque has been applied, or an audio tone.

In exemplary embodiments when the electronically readable element 20 is an electronic storage element (e.g., RFID/NFC chip), once acceptable torqueing is achieved, the torque tool can then write a torque confirmation data item to the RFID/NFC chip 20 on the fitting 10, enabling faster post-inspection. In conjunction with enhanced inspection capabilities, an LED also may be added to the RFID/NFC chip 20 on the fitting that would be a different color or flash pattern after the torque confirmation is written, powered by the RFID antenna. In this manner, effective torqueing, easy identification of fittings, and enhanced inspection, all are achieved. FIG. 3 illustrates the system in which the smart torque tool 32 is configured as a hand wrench. Such a torque tool typically is suitable for relatively smaller fittings, which are associated with operational torques in the range of about 18-120 ft-lbs. Comparable capabilities may be incorporated into a powered torque tool, or provided as an adapter added to such powered torque tool. Such a torque tool typically is suitable for relatively larger fittings which are associated with operational torques in the range of about 100-500 ft-lbs. The electronic communication and operation otherwise may be performed comparably as described with respect to FIG. 3, and thus any suitable torque tool may be employed.

In the example of FIG. 3, the electronic reading capability is integrated into the torque tool 32 or as an adapter to the torque tool. Alternatively, a separate wired or wireless RFID/NFC or patterned code reader could query the fitting, and then program the torque tool to the appropriate torque requirement via a wired or wireless connection to the torque tool.

In exemplary embodiments, additional communication links may be provided to integrate the smart torque system into a broader asset tracking system. For example, additional data storage capabilities may be incorporated into the torque tool, and the torque tool may be electronically connectable, such as by any suitable wired or wireless connection, to an external electronic device. The external electronic device may be any suitable portable electronic device, such as a tablet computer, smart phone, smart watch or like device. Such devices may have a computer application that is tied to an asset tracking system that performs such functions as inventory control, maintenance scheduling and monitoring, technician duty or operation scheduling, and like functions that pertain to the management and usage of assets. The asset tracking system may constitute a computer-based network including any suitable servers and/or cloud-based computing systems, to which the smart torque system is electronically connectable for the exchange of asset information. A technician in the field can use the portable electronic device for on-site operations, while linking up to the networked asset management system including a database of component information, maintenance schedules, and the like. The smart torque system, therefore, can permit a technician in the field to link up with a broader asset tracking system to enhance quality control and other aspects of asset management.

Another aspect of the invention is a fitting including an integrated torque sensor, which is depicted in FIG. 4. FIG. 4 depicts a fitting 40 including a fitting body and/or nut 41, and an integrated electronic torque sensor 50. In this particular depiction, the nut 41 is shown connected to a tube 42. The fitting body or nut includes a sensor housing 43 that contains the integrated electronic torque sensor 50. The integrated electronic torque sensor 50 includes an electronic sensor element 44 that includes an electronic (RFID/NFC) antenna and chip and optionally an associated output light-emitting diode (LED) indicator incorporated as part of such sensor element 44, a conductive push pin 46, and a biasing element 48. The electronic sensor element 44 is engageable with the push pin 46 that is actuated by the biasing element 48. The biasing element may be configured in any suitable manner, such as by using a spring, compressible load washer which is the example depicted in FIG. 4, or the like. Although the integrated torque sensor 50 is illustrated in this example as being incorporated into the nut, the integrated torque sensor alternatively may be incorporated into the fitting body.

As the fitting is torqued, the biasing element 48 compresses and exerts a counter force, with the level of compression and force increasing as torque increasingly is applied. At a given torque value corresponding to a torque requirement of an operational torque level of use, the force exerted by the biasing element 48 actuates the push pin 46, which contacts the electronic sensor element (RFID/NFC chip) 44. The push pin 46 may be made of any suitable conductive material, such as a conductive metal, and thus contact of the push pin 46 with the sensor element 44 operates to close or complete a circuit that is connected to the electronic sensor element. The closing of the circuit changes an internal data value stored in the sensor chip such that the fitting would recognize a torqued state. The torqued state can then be outputted or read from the electronic sensor element 44 so that a user would know the torque state of the fitting. The integrated torque sensor 50 eliminates the need for a torque wrench with an electronic torque setting capability to ascertain the appropriate torque, as the torqued state is determined and outputted by the integrated torque sensor 50. Accordingly, any standard torque tool may be used with assurance that the fitting is properly torqued.

In exemplary embodiments, the fitting 40 with the integrated torque sensor 50 may include an LED incorporated with or as part of the sensor 50 that would change color, flash rate, or other indicator mode when the torque circuit is closed or completed, allowing for visual feedback when the RFID/NFC chip is powered using a reader device (e.g., via wireless induction as per RFID/NFC technology). Alternatively, the RFID/NFC antenna of the sensor element 44 could be used with an LED light only, not a chip, with the purpose of allowing visual feedback when acceptable torque is reached. This could be beneficial because depending on the RFID range, multiple fittings or even the whole assembly could be wirelessly powered at the same time, enabling visual torqueing of all fittings and quick visual post quality assembly inspection, and at lower cost than the full RFID/NFC chip version. Alternatively, the sensor chip may be read using any suitable reading device, which may be incorporated into the torque tool as in previous embodiments, or provided as a separate reading device.

An aspect of the invention, therefore, is a smart torque system by which a torque tool can read an element on a fitting to obtain a torque requirement. In exemplary embodiments, the smart torque system includes a fitting comprising a fitting body defining a fluid flow passage from a first end to a second end, and an electronically readable element that is configured to store information about the fitting including at least a torque requirement of the fitting; an electronic reading device that reads the torque requirement from the electronically readable element; and a torque tool that is programmable by the reading device to set a torque to be applied by the torque tool in accordance with the torque requirement. The smart torque sytem may include one or more of the following features, either individually or in combination.

In an exemplary embodiment of the smart torque system, the electronically readable element comprises an electronic storage element that is programmed with the information about the fitting including at least a torque requirement of the fitting.

In an exemplary embodiment of the smart torque system, the electronic storage element comprises a radio frequency identification (RFID) or a near field communication (NFC) storage device, and the electronic reading device comprises an RFID or NFC reader respectively, and wherein power from the reading device powers the electronic storage element by induction.

In an exemplary embodiment of the smart torque system, the electronically readable element comprises a passive patterned code element that is coded to correlate to the information about the fitting including at least a torque requirement of the fitting.

In an exemplary embodiment of the smart torque system, the passive patterned code element is a barcode or QR code, and the electronic reading device comprises a code scanner.

In an exemplary embodiment of the smart torque system, the electronic reading device is incorporated into the torque tool.

In an exemplary embodiment of the smart torque system, the torque tool includes an electronics housing that houses a battery for powering the electronic reading device.

In an exemplary embodiment of the smart torque system, the fitting further comprises a nut that is attached to the fitting body, and the electronically readable element is incorporated into the nut.

In an exemplary embodiment of the smart torque system, the electronically readable element is incorporated into the fitting body.

In an exemplary embodiment of the smart torque system, the electronically readable element is incorporated into a recess provided in the fitting.

In an exemplary embodiment of the smart torque system, the system further includes an indicator that indicates to a user that the fitting has been torqued in accordance with the torque requirement.

In an exemplary embodiment of the smart torque system, the indicator includes a light-emitting diode that emits light in a manner that indicates whether the fitting has been torqued in accordance with the torque requirement.

In an exemplary embodiment of the smart torque system, the indicator is provided on the fitting.

In an exemplary embodiment of the smart torque system, the indicator is provided on the torque tool.

In an exemplary embodiment of the smart torque system, the indicator includes a display device incorporated into the torque tool.

Another aspect of the invention is a fitting including an integrated torque sensor for enhanced torque accuracy. In exemplary embodiments, the fitting includes a fitting body defining a fluid flow passage from a first end to a second end, and an integrated torque sensor. The integrated torque sensor includes an electronic sensor element; a push pin that is engageable with the electronic sensor element to close a circuit connected to the electronic sensor element; and a biasing element that is configured to actuate the push pin. When the fitting is torqued in accordance with a torque requirement of the fitting, the biasing element actuates the push pin to engage with the electronic sensor element to close the circuit, and a stored data item within the electronic sensor element changes to indicate the fitting is torqued in accordance with the torque requirement. The fitting may include one or more of the following features, either individually or in combination.

In an exemplary embodiment of the fitting, the electronic sensor element comprises a radio frequency identification (RFID) or a near field communication (NFC) storage device, and wherein the stored data item is readable from the electronic sensor element with an RFID or NFC reading device respectively.

In an exemplary embodiment of the fitting, the biasing element includes a compressible load washer.

In an exemplary embodiment of the fitting, the fitting further includes an indicator that indicates to a user that the fitting has been torqued in accordance with the torque requirement.

In an exemplary embodiment of the fitting, the fitting further includes a nut that is attached to the fitting body, and the integrated torque sensor is incorporated into the nut.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A smart torque system comprising:
a fitting comprising a fitting body defining a fluid flow passage from a first end to a second end, and an electronically readable element incorporated into the fitting that is configured to store information about the fitting including at least a torque requirement of the fitting; an electronic reading device that reads the torque requirement from the electronically readable element; and
a torque tool that is programmable by the reading device to set a torque to be applied by the torque tool in accordance with the torque requirement, wherein the electronic reading device is incorporated into the torque tool.

2. The smart torque system of claim 1, wherein the electronically readable element comprises an electronic storage element that is programmed with the information about the fitting including at least a torque requirement of the fitting.

3. The smart torque system of claim 2, wherein the electronic storage element comprises a radio frequency identification (RFID) or a near field communication (NFC) storage device, and the electronic reading device comprises an RFID or NFC reader respectively, and wherein power from the reading device powers the electronic storage element by induction.

4. The smart torque system of claim 1, wherein the electronically readable element comprises a passive patterned code element that is coded to correlate to the information about the fitting including at least a torque requirement of the fitting.

5. The smart torque system of claim 4, wherein the passive patterned code element is a barcode or QR code element, and the electronic reading device comprises a code scanner.

6. The smart torque system of claim 5, wherein the torque tool includes an electronics housing that houses a battery for powering the electronic reading device.

7. The smart torque system of any of claim 1, wherein the fitting further comprises a nut that is attached to the fitting body, and the electronically readable element is incorporated into the nut.

8. The smart torque system of claim 1, wherein the electronically readable element is incorporated into the fitting body.

9. The smart torque system of claim 1, wherein the electronically readable element is incorporated into a recess provided in the fitting.

10. The smart torque system of any of claim 1, further comprising an indicator that indicates to a user that the fitting has been torqued in accordance with the torque requirement.

11. The smart torque system of claim 10, wherein the indicator includes a light-emitting diode that emits light in a manner that indicates whether the fitting has been torqued in accordance with the torque requirement.

12. The smart torque system of any of claim 10, wherein the indicator is provided on the fitting.

13. The smart torque system of any of claim 10, wherein the indicator is provided on the torque tool.

14. The smart torque system of claim 10, wherein the indicator includes a display device incorporated into the torque tool.

15. A fitting comprising:
a fitting body defining a fluid flow passage from a first end to a second end; and
an integrated torque sensor, wherein the integrated torque sensor comprises: an electronic sensor element;
a push pin that is engageable with the electronic sensor element to close a circuit connected to the electronic sensor element; and
a biasing element that is configured to actuate the push pin, wherein when the fitting is torqued in accordance with a torque requirement of the fitting, the biasing element actuates the push pin to engage with the electronic sensor element to close the circuit, and a stored data item within the electronic sensor element changes to indicate the fitting is torqued in accordance with the torque requirement.

16. The fitting of claim 15, wherein the electronic sensor element comprises a radio frequency identification (RFID) or a near field communication (NFC) storage device, and wherein the stored data item is readable from the electronic sensor element with an RFID or NFC reading device respectively.

17. The fitting of claim 15, wherein the biasing element includes a compressible load washer.

18. The fitting of claim 15, further comprising an indicator that indicates to a user that the fitting has been torqued in accordance with the torque requirement.

19. The fitting of claim 15, further comprising a nut that is attached to the fitting body, and the integrated torque sensor is incorporated into the nut.

20. (canceled)
